(19) United States
(12) Patent Application Publication
(10) Pub. No.: US 2016/0303786 A1
(43) Pub. Date: Oct. 20, 2016

(54) INJECTION MOLD

(71) Applicants: Boe Technology Group Co., Ltd., Beijing (CN); Boe Optical Science and Technology Co., Ltd., Suzhou (CN)

(72) Inventors: Xiaoning He, Beijing (CN); Zeqing Wu, Beijing (CN)

(21) Appl. No.: 15/089,712

(22) Filed: Apr. 4, 2016

(30) Foreign Application Priority Data
Apr. 15, 2015 (CN) 201510177982.6

(51) Int. Cl. B29C 45/73

(52) U.S. Cl. CPC B29C 45/7312; B29C 45/73; B29C 45/7337; B29K 2995/0013

(57) ABSTRACT

An injection mold arranged with a cooling water way. The water way reduces the technical difficulty of mold manufacturing. The injection mold comprises a front die core and a back die core, wherein a cavity exists between the front die core and the back die core. The injection mold further comprises at least one cooling plate of die core, the surface of the cooling plate of die core is attached to the surfaces of the front die core and/or the back die core, a cooling water way is provided in the cooling plate of die core. The embodiments of the invention are used for injection molds.

### CROSS REFERENCE OF RELATED APPLICATION

The present application claims the benefit of Chinese Patent Application No. 201510177982.6, filed by Apr. 15, 2015, the entire disclosure of which is incorporated herein by reference.

### TECHNICAL FIELD

The application refers to a technical field of moldings, and specifically to an injection mold.

### BACKGROUND

An injection mold is a tool for manufacturing plastic products, and is broadly applied in the processing industry of plastic products, since it can manufacture a product having an integral structure and precise dimensions. During manufacturing plastic products by an injection mold, a hot melting principle for plastic is mainly applied, and the melted plastic is injected into the cavity of the mold by the injection molding machine, and then is cooled and sized, and a molded product can be obtained by opening the mold. During this injection molding, cooling effects (good and/or bad) affect directly the yield rate of the product.

In the prior art, different products need different injection molds. Exemplarily, during manufacturing a plate-type product, such as a light guiding plate, a liquid crystal panel, etc., the injection mold is normally as shown in FIG. 1, which is only a partial structure schematic diagram of an injection mold. A cooling water way 101 is provided in the die core 102 of the injection mold. The temperature of the die core 102 is reduced by the low temperature of the cooling water in the cooling water way 101, and in turn the temperature of the product in the cavity 103 which contacts with the die core 102 is reduced, obtaining the object of cooling the product in the cavity 103. In the prior art, the die core 102 of the injection mold belongs to a precise component, and normally the die core 102 consists of multiple die core sections. Exemplarily, as shown in FIG. 1, the die core is divided as a front die core 1021 and a back die core 1022, wherein the back die core 1022 consists of a die core section 10221, a die core section 10222 and a die core section 10223. These die core sections are normally connected by bolts, and thus there are many screw holes, insert holes or other hole structures on the die core 102. It is hard to arrange the cooling water way 101 while avoiding these holes, which in turn results in larger manufacturing difficulty of the injection mold.

### SUMMARY

An embodiment of the invention provides an injection mold, which can be provided a cooling water way conveniently and reduces the technical difficulty of mold manufacturing.

For obtaining the above object, an embodiment of the invention employs the following technical solution:

One embodiment of the invention provides an injection mold, comprising a front die core and a back die core. A cavity exists between the front die core and the back die core, and the injection mold further comprises at least one cooling plate of die core. The surface of the cooling plate of die core is attached to the surfaces of the front die core and/or the back die core. A cooling water way is provided in the cooling plate of die core.

Optionally, the thermal conductivity of the cooling plate of die core is larger than the thermal conductivities of the front die core and/or the back die core attached to the cooling plate of die core.

Optionally, the thermal conductivity of the cooling plate of die core is larger than or equal to 200 W/(m·K).

Optionally, the front die core and the back die core both comprise a first surface and a second surface, the first surface being a surface constituting the cavity, the second surface being a surface opposite to the first surface, and the surface of the cooling plate of die core is attached to the second surfaces of the front die core and/or the back die core.

Optionally, the injection mold comprises two cooling plates of die core, which are a first cooling plate of die core and a second cooling plate of die core respectively. The surface of the first cooling plate of die core is attached to the second surface of the front die core. The surface of the second cooling plate of die core is attached to the second surface of the back die core.

Optionally, the cooling water way is distributed uniformly in the cooling plate of die core.

Optionally, the cooling plate of die core is made of Beryllium Copper.

Optionally, the cooling plate of die core is provided with a heating water way.

Optionally, the heating water way and the cooling water way are distributed interlacing with each other.

Optionally, the cooling water way is used as a heating water way during injection, and the heat water way is used as a cooling water way during cooling of the mold. Further optionally, the fluid in the heating water way may be water vapor.

Optionally, the cooling plate of die core is fixed with the front die core and/or the back die core by blots.

Optionally, the cooling plate of die core is embedded into the front die core and/or the back die core by interference fit.

The injection mold provided by the embodiments of the invention comprises a front die core and a back die core. A cavity exists between the front die core and the back die core, and the injection mold further comprises at least one cooling plate of die core. The surface of the cooling plate of die core is attached to the surfaces of the front die core and/or the back die core. A cooling water way is provided in the cooling plate of die core. Compared to the prior art (which arranges the cooling water way in the die core composed of multiple die core sections, and the structures such as the screw holes, insert holes for connecting the die core sections need to be bypassed, resulting in a larger difficulty during arranging the cooling water way, and it is harder to reach a uniform arrangement), the injection mold provided by the embodiments of the invention arranges the cooling water way into the cooling plate of die core. Since the cooling plate of the die core is an integral structure, on which there are not many structures such as screw holes, insert holes, the technical difficulty of arranging the cooling water way is smaller, and the cooling water way can be arranged as uniformly as possible, making the product to receive more uniform cooling, thus reducing the warping and deformation and local stress mark of the product, and improving the yield rate of the product. Additionally or alternatively, since there is no need to arrange the cooling water way in the die core, the manufacturing process of the die core is simplified, the manufacturing difficulty of die core is reduced, and the thickness of the die core can be reduced, the manufacturing cost of the mold is reduced. Additionally, the cooling plate of die core can be reused, which further saves the cost.

### BRIEF DESCRIPTION OF FIGURES

In order to more clearly illustrate the technical solutions of the embodiments of the invention or the prior art, the figures needed to be used in the description of the embodiments or the prior art will be simply introduced in the following. Apparently, the figures in the following description only show some embodiments of the invention. For those common skilled in the art, other embodiments can be obtained according to these figures without applying creative effort. It should be understood that, the various parts in the figures may not be drawn to scale, and on the contrary, dimensions of some parts may be exaggerated as required.

FIG. 1 is a structure schematic view of an injection mold provided by the prior art;

FIG. 2 is a structure schematic view of an injection mold provided by an embodiment of the invention;

FIG. 3 is a temperature zone distribution view of the injection mold provided by the prior art when being cooled;

FIG. 4 is a structure schematic view of an injection mold provided by another embodiment of the invention;

FIG. 5 is a structure schematic view of an injection mold provided by still another embodiment of the invention;

FIG. 6 is a structure schematic view of an injection mold provided by yet another embodiment of the invention;

FIG. 7 is a structure schematic view of an injection mold provided by further another embodiment of the invention.

### DETAILED DESCRIPTION

The technical solutions of the embodiments of the invention will be described clearly and completely below in conjunction with the figures in the embodiments of the invention. Apparently, the embodiments described are only a part of the embodiments of the invention, rather than all of the embodiments. Based on the embodiments of the invention, all other embodiments obtained by those skilled in the art without creative effort are within the protection scope of the invention.

An embodiment of the invention provides an injection mold, as shown in FIG. 2, which comprises a front die core 201 and a back die core 202, a cavity 203 exists between the front die core 201 and the back die core 202, and the injection mold 20 further comprises at least one cooling plate 204 of die core. The surface of the cooling plate 204 of die core is attached to the surfaces of the front die core 201 and/or the back die core 202. A cooling water way 205 is provided in the cooling plate 204 of die core. In an example, the water way may be a water circuit or water channel.

Therein, the at least one cooling plate of die core may comprises one cooling plate of die core, or multiple cooling plates of die core. In the embodiment of the invention, the number of the cooling plates of die core provided is unlimited. In a practical application, the number of the cooling plates of die core can be set in overall consideration of the material and thickness of the product, the cooling temperature of the product etc. At the same time, the shape and the size of the cooling plate 204 of die core are unlimited. Exemplarily, the cooling plate 204 of die core may be a cuboid or a cube, or the surface of the cooling plate 204 of die core may present some radian, etc. In a normal situation, the shape and size of the cooling plate 204 of die core are consistent with the shape and size of the die core attached, and the shape and size of the die core are determined normally according to the shape and size of the product in the cavity 203. Since the structure of the cavity of the plate product is simple, normally a cuboid, the shapes of corresponding die core and cooling plate of die core are relatively simple. Therefore, for making the description easy, the following described embodiments of the invention take an injection mold for the plate product as an example for illustration, but the embodiments of the invention are not limited to this.

As shown in FIG. 2, the surface of the cooling plate 204 of die core is attached to the surfaces of the front die core 201 or the back die core 202, and thus there is not a gap between the cooling plate 204 and the front die core 201 or the back die core 202. Therefore, an efficient heat conduction between the cooling plate 204 and the front die core 201 or the back die core 202 can be guaranteed, and in turn a good cooling effect of the product can be guaranteed. It should be noted that, the fixing ways of the cooling plate 204 of die core and the front die core 201 or the back die core 202 may be of many kinds. Exemplarily, the cooling plate 204 of die core may be fixed with the front die core 201 or the back die core 202 by bolts, or the cooling plate 204 of die core may be embedded into the front die core 201 or the back die core 202 by way of inference fit, etc. Since the technical cost of the way of inference fit is higher, preferably, the cooling plate 204 of die core is fixed with the front die core 201 or the back die core 202 by bolts.

The cooling plate 204 of die core may be made of multiple materials, which can be determined by those skilled in the art according to the actual situation, and for example, is Beryllium Copper.

As shown in FIG. 2, the cooling water way 205 is provided in the cooling plate 204 of die core, and thus the cooling water way 205 does not need to bypass the structures such as screw holes, insert holes which may exist in the front die core 201 and the back die core 202, reducing the technical difficulty of arranging the cooling water way 205.

As such, compared to the prior art (it arranges the cooling water way in the die core composed of multiple die core sections, and the structures such as the screw holes, insert holes for connecting the die core sections need to be bypassed, resulting in a larger difficulty during arranging the cooling water way, and it is harder to reach a uniform arrangement), the injection mold provided by the embodiments of the invention arranges the cooling water way into the cooling plate of die core. Since the cooling plate of die core is an integral structure, on which there are no many structures such as screw holes, insert holes, the technical difficulty of arranging the cooling water way is smaller, and the cooling water way can be arranged as uniformly as possible, making the product to obtain more uniform cooling, reducing the warping and deformation and local stress mark of the product, and improving the yield rate of the product. Besides, since there is no need to arrange the cooling water way in the die core, the manufacturing process of the die core is simplified, the manufacturing difficulty of die core is reduced, and the thickness of the die core can be reduced, the manufacturing cost of the mold is reduced.

Further, the thermal conductivity of the cooling plate of die core is larger than the thermal conductivities of the front die core and/or the back die core attached to the cooling plate of die core.

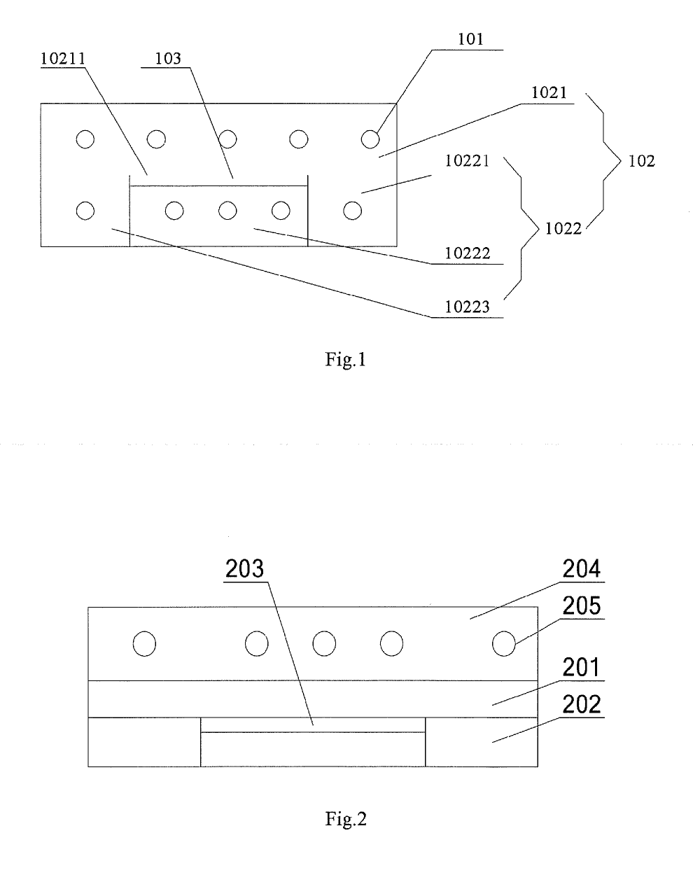

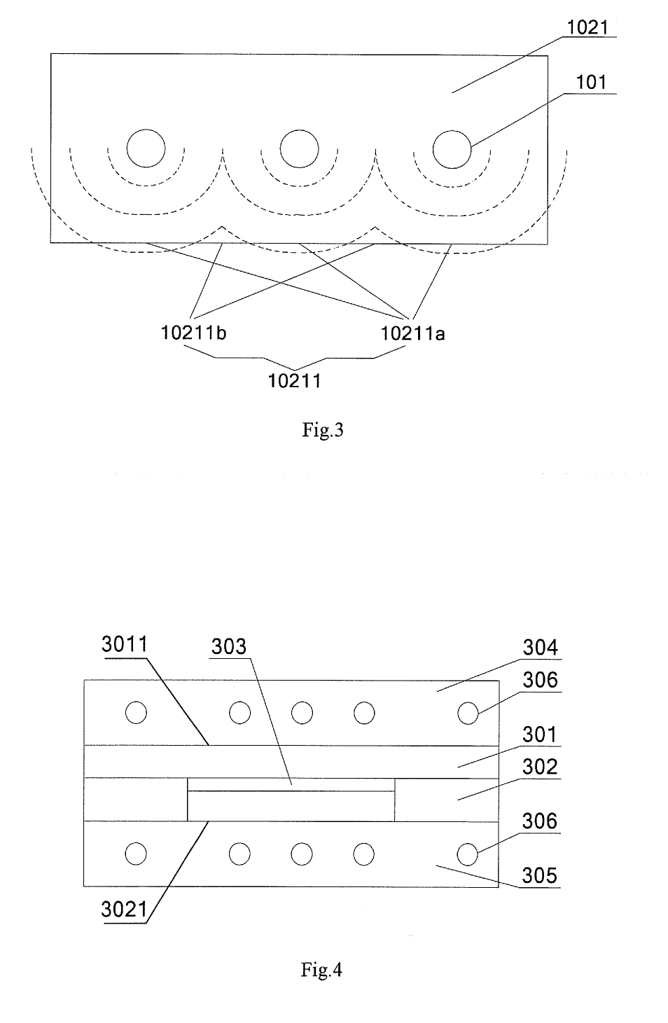

In the prior art, as shown in FIGS. 1 and 3, due to the thermal conduction characteristic of the temperature, that is the temperature of the zone close to a heat source is higher and the temperature of the zone far away from the heat source is lower, an intervallic temperature zone distribution will be formed on the surface of the die core, that is, the temperature of the zone close to the cooling water way 101 is lower, and the temperature of the zone far away from the cooling water way 101 is higher. Taking the surface 10211 of the front die core as an example for illustration, as shown in FIG. 3, due to the arrangement of the cooling water way 101, an intervallic temperature zone distribution is formed on the surface 10211 of the front die core, that is the low temperature zone 10211a close to the cooling water way 101 and the high temperature zone 10211b far way from the cooling water way 101 are distributed interlacing with each other. Thus a wave-shaped cooling effect will be present in the product in the cavity 103, and since the product does not receive uniform cooling, warping and deformation and local stress mark of the product will be easily generated, reducing the yield rate of the product.

When the thermal conductivity of the cooling plate of die core is larger than the thermal conductivities of the front die core and/or the back die core attached to it, the characteristic of higher thermal conductivity of the cooling plate of die core would make the surface of the cooling plate of die core more quickly to reach a uniform temperature, and thus the transfer of the heat of the product in the cavity through the front die core or the back die core attached to the cooling plate of die core to the cooling plate of die core is more even. Therefore, the product will receive more uniform cooling, reducing the warping and deformation and local stress mark of the product caused by the uneven cooling in the prior art, which in turn improves the yield rate of the product. Preferably, the thermal conductivity of the cooling plate of die core larger than or equal to 200 W/(m·K) can ensure the surface of the cooling plate of die core reaches uniform temperature quickly during mold cooling, which ensures the product is cooled uniformly.

Further, the front die core and the back die core both comprise a first surface and a second surface, the first surface constitutes the surface of the cavity, the second surface is a surface opposite to the first surface, and the surface of the cooling plate of die core is attached to the second surface of the front die core or the back die core.

Further, as shown in FIG. 4, the injection mold comprises two cooling plates of die core, which are a first cooling plate 304 of die core and a second cooling plate 305 of die core respectively; the surface of the first cooling plate 304 of die core is attached to the second surface 3011 of the front die core 301; the surface of the second cooling plate 305 of die core is attached to the second surface 3021 of the back die core 302.

As shown in FIG. 4, the first cooling plate 304 of die core and the second cooling plate 305 of die core are arranged at a side of the front die core 301 and the second die core 302 far away from the cavity 303. Since cooling water ways 306 are provided in both the two cooling plates of die core, the front and back sides of the product in the cavity 303 can both receive uniform cooling, reducing the possibility of the product occurring warping and deformation and local stress mark, which in turn improves the yield rate of the product.

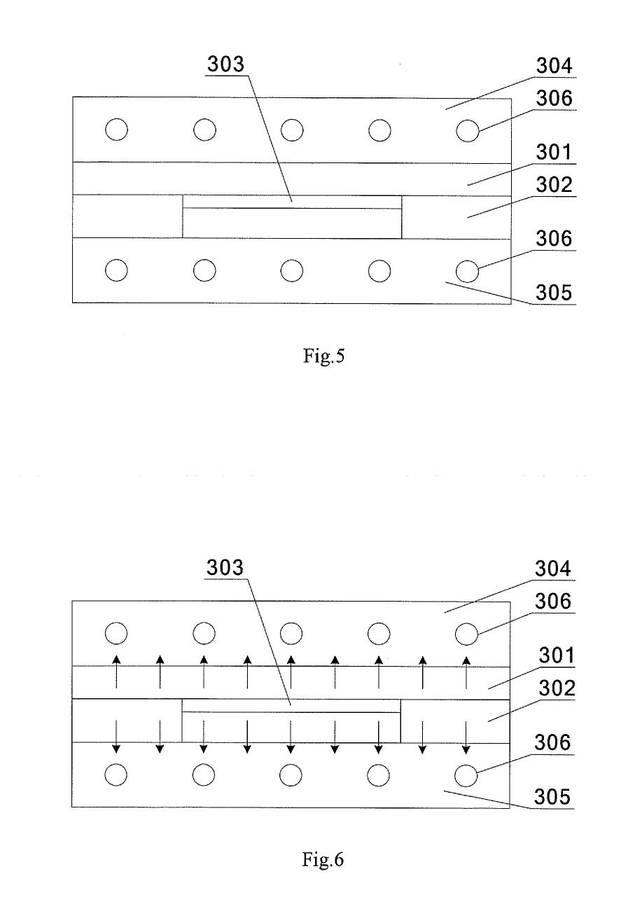

Further, as shown in FIG. 5, the cooling water way 306 is provided in the cooling plate of die core uniformly.

Therein, the cooling plate of die core may be made of Beryllium Copper. Beryllium Copper is a copper alloy with beryllium as an alloying element, and is broadly applied in the injection mold due to having the benefits such as high elasticity, high intensity, high electrical conductivity, high thermal conductivity, corrosion resistance, etc. The thermal conductivity of the Beryllium Copper is normally between 200-300 W/(m·K). Making the cooling plate of die core with the Beryllium Copper can well ensure the heat conduction efficiency of the cooling plate of die core, which in turn guarantees the uniformity of cooling the product.

In the embodiments of the invention, the temperature value of the cooling water in the cooling water way 306 is unlimited, and can be set by those skilled in the art according to experiments or tests in actual applications.

As shown in FIG. 5, since the cooling water way 306 is provided in the cooling plate of die core, the structures such as the screw holes, insert holes etc. in the front die core 301 and the back die core 302 are not needed to be bypassed, the cooling water way 306 in the cooling plate of die core can be arranged uniformly. As such, during cooling the mold, the diffusion of the heat from the front die core 301 and the back die core 302 to the cooling plate of die core is more uniform, which in turn makes the cooling of the product in the cavity more uniform. As shown in FIG. 6, the arrows in the FIG. 6 show the transfer directions of the heat during cooling by the cooling water way 306.

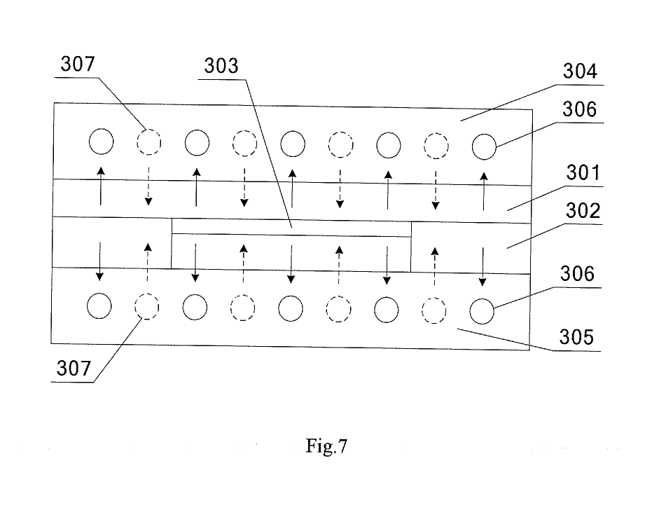

Further, as shown in FIG. 7, the cooling plate of die core is provided with a heating water way 307.

By providing the heating water way 307 in the cooling plate of die core, when the melted material for the product is injected into the cavity 303, the heating water way 307 can maintain the temperature of the injection channel and the cavity 303, making the injection progress to be performed smoothly, which in turn improves the yield rate of the product.

Therein, the heating fluid in the heating water way 307 may have many kinds, which are not limited in the embodiments of the invention. Since the water vapor can be obtained easily and has a lower cost, preferably, the heating fluid in the heating water way 307 may be the water vapor, the temperature of which can be set according to the actual situation.

As shown in FIG. 7, in the actual application, the cooling water way 306 and the heating water way 307 can be arranged interlaced with each other in the cooling plate of die core. When the melted material for the product is injected into the cavity 303, the heating water way 307 is opened, enabling the injection channel and the cavity 303 maintain at a higher temperature and enabling the injection progress be performed smoothly. At this time, the heat flows into the cavity 303 from the cooling plate of die core, that is, as shown in the dashed arrows in the FIG. 7. When it is needed to cool down the product in the cavity 303, the cooling water way 306 is opened, making the product in the cavity 303 to be cooled rapidly. At this time, the heat flows from the cavity 303 to the cooling plate of die core, as shown in the solid arrows in FIG. 7. In an optional embodiment, during different processes, the functions of the heating water way and the cooling water way can be exchanged.

The injection mold provided by the embodiments of the invention comprises a front die core and a back die core, a cavity exists between the front die core and the back die core, and the injection mold further comprises at least one cooling plate of die core; the surface of the cooling plate of die core is attached to the surfaces of the front die core and/or the back die core; a cooling water way is provided in the cooling plate of die core. Compared to the prior art (it arranges the cooling water way in the die core composed of multiple die core sections, and the structures such as the screw holes, insert holes for connecting the die core sections need to be bypassed, resulting in a larger difficulty during arranging the cooling water way, and it is harder to reach a uniform arrangement), the injection mold provided by the embodiments of the invention arranges the cooling water way into the cooling plate of die core; since the cooling plate of die core is an integral structure, on which there are no many structures such as screw holes, insert holes, the technical difficulty of arranging the cooling water way is smaller, and the cooling water way can be arranged as uniformly as possible, making the product to receive more uniform cooling, reducing the warping and deformation and local stress mark of the product, and improving the yield rate of the product. Besides, since there is no need to arrange the cooling water way in the die core, the manufacturing process of the die core is simplified, the manufacturing difficulty of die core is reduced, and the thickness of the die core can be reduced, the manufacturing cost of the mold is reduced.

The above described are only specific implementations of the invention, and the protection scope of the invention is not limited to this. The variations or substitutions easily thought of by those skilled in the art in the technical scope disclosed by the invention should be covered within the protection scope of the invention. Therefore, the protection scope of the invention should be only defined by the protection scope of the claims. It should be noted that, the word “comprise” or “comprising” does not exclude presence of elements or steps that are not listed in the claims. The word “a” or “an” preceding an element does not exclude presence of a plurality of such elements. The mere fact that certain measures are recited in mutually different dependent claims does not indicate that a combination of these measures cannot be used to advantage. Any reference signs in the claims should not be construed as limiting the scope.

1. An injection mold, comprising a front die core and a back die core,
wherein a cavity exists between the front die core and the back die core;
wherein the injection mold further comprises at least one cooling plate of die core;
wherein the surface of the cooling plate of die core is attached to the surfaces of the front die core and/or the back die core; and
wherein a cooling water way is provided in the cooling plate of die core.

2. The injection mold according to claim 1, wherein a thermal conductivity of the cooling plate of die core is larger than a thermal conductivity of the front die core and/or a thermal conductivity of the back die core attached to the cooling plate of die core.

3. The injection mold according to claim 2, wherein the thermal conductivity of the cooling plate of die core is larger than or equal to 200 W/(m·K).

4. The injection mold according to claim 1, wherein the front die core and the back die core both comprise a first surface and a second surface, the first surface being a surface constituting the cavity, the second surface being a surface opposite to the first surface, and the surface of the cooling plate of die core is attached to the second surfaces of the front die core and/or the back die core.

5. The injection mold according to claim 4, wherein the injection mold comprises two cooling plates of die core, wherein the two cooling plates are a first cooling plate of die core and a second cooling plate of die core respectively;
wherein the surface of the first cooling plate of die core is attached to the second surface of the front die core; and
wherein the surface of the second cooling plate of die core is attached to the second surface of the back die core.

6. The injection mold according to claim 1, wherein the cooling water way is distributed uniformly in the cooling plate of die core.

7. The injection mold according to claim 2, wherein the cooling water way is distributed uniformly in the cooling plate of die core.

8. The injection mold according to claim 4, wherein the cooling water way is distributed uniformly in the cooling plate of die core.

9. The injection mold according to claim 5, wherein the cooling water way is distributed uniformly in the cooling plate of die core.

10. The injection mold according to claim 1, wherein the cooling plate of die core is made of Beryllium Copper.

11. The injection mold according to claim 1, wherein the cooling plate of die core is provided with a heating water way.

12. The injection mold according to claim 2, wherein the cooling plate of die core is provided with a heating water way.

13. The injection mold according to claim 4, wherein the cooling plate of die core is provided with a heating water way.

14. The injection mold according to claim 5, wherein the cooling plate of die core is provided with a heating water way.

15. The injection mold according to claim 11, wherein the heating water way and the cooling water way are distributed interlacing with each other.

16. The injection mold according to claim 11, wherein the cooling water way is used as a heating water way during injection, and the heat water way is used as a cooling water way during cooling of the mold.

17. The injection mold according to claim 15, wherein the fluid in the heating water way is water vapor.

18. The injection mold according to claim 1, wherein the cooling plate of die core is fixed with the front die core and/or the back die core by blots.

19. The injection mold according to claim 1, wherein the cooling plate of die core is embedded into the front die core and/or the back die core by interference fit.
